(19) United States
(12) Patent Application Publication
(10) Pub. No.: US 2026/0254492 A1
(43) Pub. Date: Aug. 27, 2026

(54) METHOD OF TRIGGERING COORDINATED SPATIAL REUSE OR COORDINATED BEAMFORMING IN WI-FI COMMUNICATIONS

(71) Applicant: HUAWEI TECHNOLOGIES CO., LTD., SHENZHEN (CN)

(72) Inventors: Jung Hoon SUH, Kanata (CA); Mahmoud HASABELNABY, Kanata (CA); Yan XIN, Kanata (CA); Osama ABOUL-MAGD, Kanata (CA); Abdalla Mohamed Abdelaziz Mahmoud HUSSEIN, Kanata (CA); Sara NOROUZI, Kanata (CA)

(73) Assignee: HUAWEI TECHNOLOGIES CO., LTD., SHENZHEN (CN)

(21) Appl. No.: 19/324,948

(22) Filed: Sep. 10, 2025

Related U.S. Application Data
(60) Provisional application No. 63/763,677, filed on Feb. 26, 2025.
(60) Provisional application No. 63/766,189, filed on Mar. 3, 2025.
(60) Provisional application No. 63/767,918, filed on Mar. 6, 2025.
(60) Provisional application No. 63/785,509, filed on Apr. 8, 2025.

(51) Int. Cl. H04B 7/06; H04L 69/323

(52) U.S. Cl. CPC H04B 7/0617; H04L 69/323

(57) ABSTRACT

Methods are disclosed of initiating coordinated beamforming or coordinated spatial reuse using a trigger frame. The trigger frame can repurpose fields in an existing trigger type or it can define a new trigger type with extra space via fields for trigger dependent user info or common info. The trigger frame provides allocation info of spatial streams to access points and stations for participating in transmitting and receiving a downlink coordinated beamforming or coordinated spatial reuse physical layer protocol data unit, and optionally such allocation info for sending block acknowledgements, which may be sequential or simultaneous.

### CROSS-REFERENCE TO RELATED APPLICATIONS

This application claims the benefit of and priority to U.S. Provisional Application 63/763,677 filed on Feb. 26, 2025, U.S. Provisional Application 63/766,189 filed on Mar. 3, 2025, U.S. Provisional Application 63/767,918 filed on Mar. 6, 2025, and U.S. Provisional Application 63/785,509 filed on Apr. 8, 2025, the contents of which are incorporated herein by reference.

### FIELD OF THE INVENTION

The present application pertains to communication networks and in particular to methods, systems and apparatus for access point coordination in communication networks.

### BACKGROUND

In past versions of IEEE 802.11, or Wi-Fi™ (trademark of the Wi-Fi Alliance) networks, access points (APs) on the same channel within transmission and reception range of one another have had to access the medium on a one-at-a-time basis, first sensing the energy level on the medium and waiting a backoff time before attempting to contend for the medium and win a transmission opportunity (TXOP). Such a TXOP would belong to a single AP only. Beginning with the sixth generation of Wi-Fi™ networks, multiple stations (STAs) could transmit on the same TXOP using different frequency resource allocations via orthogonal frequency division multiple access (OFDMA). An AP would have to trigger synchronized transmission of a physical layer protocol data unit (PPDU) using a trigger frame (TF) sent to multiple STAs. However, no more than one AP could still transmit at a time. The eighth generation of Wi-Fi™ networks plans to introduce multi-AP coordination, allowing more than one AP to use a channel and a TXOP at a time through coordinated spatial reuse (Co-SR) and coordinated beamforming (Co-BF).

An AP that wins a TXOP may choose to initiate multi-AP coordination with one other AP within a usable signal range. At this point the TXOP winner takes on the role of ‘Sharing AP’, and the chosen other AP takes on the role of ‘Shared AP’. Multi-AP coordination may constitute Co-SR or Co-BF. Co-BF in a TXOP may use both a sounding stage and a transmission stage, in each of which information may be exchanged between each AP in collaboration and its associated STA(s) before the sounding packets are transmitted and the Co-BF PPDUs are transmitted. Transmission of a trigger frame from the Sharing AP is done before the Co-SR or Co-BF downlink (DL) PPDU can be transmitted by both the Sharing and Shared APs in a TXOP-based transmission stage. Control information including, for example, the number of total spatial streams (SSs) scheduled across the coordinated APs needs to be known to the Co-BF-scheduled STAs. Existing trigger frame formats do not carry control information suitable for enabling Co-BF or Co-SR between multiple APs.

The TXOP-based Co-SR/Co-BF transmission stage can begin with exchange of initial control frames/initial control responses (ICF/ICR) between the coordinated APs. The ICF/ICR frames may also be referred to as invite/response frames but function identically regardless of nomenclature chosen. FIG. 2 of the present disclosure, described further hereinbelow, shows a call diagram of the Co-SR/Co-BF transmission stage, as found in K. Aio, et. al., “CSR/COBF Protocol Design”, IEEE 802.11-24/2060r0, corresponding to a TXOP which has been won by the Sharing AP.

In the case of CoSR, the ICF/ICR exchange between each AP and its associated STA(s) may be optional except for in a Co-SR eMLSR/DPS mode, wherein eMLSR stands for enhanced multi-link single-radio and DPS stands for dynamic power save. By contrast, the ICF/ICR exchange between each AP and its associated STA(s) is used in Co-BF and may not be used in the majority of other Co-SR modes.

The Aio reference, as well as contributions from Verma, et. al. “MAC protocol aspects of multi-AP coordination”, IEEE 802.11-24/639r1, and Kim, et. al., “Multi-AP framework for C-SR”, IEEE 802.11-24/1514r1, provide a general framework of the Co-BF/Co-SR setup process but do not teach trigger frames capable of providing sufficient control information.

The block acknowledgment (Block Ack or BA) frames transmitted by the non-AP STAs associated with the coordinated APs can be transmitted simultaneously as seen in FIG. 2. However, other BA arrangements between the basic service set (BSS) served by the Sharing AP and the overlapping basic service set (OBSS) served by the Shared AP may be preferable in certain situations after the polling from their associated APs occurs. The simultaneous BA transmission may require the scheduling information to be indicated beforehand, prior to the Co-BF/Co-SR DL PPDU transmission, and there may be insufficient signaling overhead space to accomplish this depending on the format of the Co-BF/Co-SR trigger frame.

New trigger frame formats and block acknowledgement arrangements are sought that overcome deficiencies in the prior art.

This background information is provided to reveal information believed by the applicant to be of possible relevance to the present invention. No admission is necessarily intended, nor should be construed, that any of the preceding information constitutes prior art against the present invention.

### SUMMARY

The present disclosure provides methods for control information to be indicated in the detection of a CoBF DL PPDU at a receiver's side, and for BA to be sequentially indicated after receiving the CoBF/COSR DL PPDU.

According to a first broad aspect of the disclosure, a method at an access point (AP) of communicating using multi-AP coordination (MAPC) comprises transmitting, from a first AP, a trigger frame containing Coordinated Beamforming or Coordinated Spatial Re-use (Co-BF/Co-SR) Scheduling Information including: address information referring to a second AP; a set of bits indicating a number of a plurality of wireless stations scheduled by each of the first AP and the second AP for a downlink (DL) Co-BF/Co-SR PPDU; an indication of a first number of spatial streams for the first AP to transmit in the DL Co-BF/Co-SR PPDU; an indication of a second number of spatial streams for the second AP to transmit in the DL Co-BF/Co-SR PPDU; and a two-bit indication of a cumulative total number of LTF transmitted by the first and second APs in the DL Co-BF/Co-SR PPDU.

The method further comprises transmitting, from the first AP to the plurality of wireless stations, a first portion of the DL Co-BF/Co-SR PPDU, the first portion comprising a set of spatial streams equal in number to the first number of spatial streams, in synchronization with a second portion of the PPDU transmitted by the second AP, the second portion comprising a set of spatial streams equal in number to the second number of spatial streams; and receiving one or more block acknowledgement (BA) frames transmitted from the plurality of wireless stations.

In some embodiments, the trigger frame comprises a User Info List, wherein address information referring to a second AP is the AID12 of the second AP stored in the first 12 bits of a first user info field of the user info list.

In some embodiments, the trigger frame comprises a common info field with a trigger type set not to allow Trigger Dependent User Info in the User Info List.

In some embodiments, the first user info field is eighty bits long, the AID12 of the second AP is repeated at bits B40 to B51 of the first user info field, and the Co-BF/Co-SR Scheduling Information is stored in at least a subset of the bits comprising B12 to B39 and B52 to B79 of the first user info field.

In some embodiments, the first user info field is 120 bits long, the AID12 of the second AP is repeated at bits B40 to B51 and B80 to B91 of the first user info field, and the Co-BF/Co-SR Scheduling Information is stored in at least a subset of the bits comprising B52 to B79 and B92 to B119 of the first user info field.

In some embodiments, the trigger frame comprises a common info field with a trigger type set to allow Trigger Dependent User Info in the User Info List.

In such cases the first user info field may comprise the AID12 of the second AP; a set of 28 bits beyond the AID12 of the second AP; and a set of Trigger Dependent User Info bits beyond the 28 bits; wherein the Co-BF/Co-SR Scheduling Information is stored in at least a subset of the bits comprising the set of 28 bits and the set of Trigger Dependent User Info bits.

In some embodiments, wherein Trigger Dependent User Info is allowed, the common info field trigger type is set to a value greater than 8 to define a new trigger type.

In some embodiments, the trigger frame comprises a common info field containing a Trigger Dependent Common Info subfield, a trigger type set to a value greater than 8, and a Bit B55 indicating the absence of a Special User Info Field, wherein the Co-BF/Co-SR Scheduling Information is stored in at least a subset of Common Info Field bits comprising B4 to B54, B56 to B63, and the Trigger Dependent Common Info subfield.

In a second broad aspect of the disclosure, the Co-BF/Co-SR Scheduling Information comprises resource unit and spatial stream (RU/SS) allocations for use in block acknowledgement (BA) by a portion of the plurality of wireless stations associated with the first AP.

In some embodiments of the second aspect, the Co-BF/Co-SR Scheduling Information comprises resource unit and spatial stream (RU/SS) allocations for use in BA by a portion of the plurality of wireless stations associated with the second AP.

In some embodiments of the second aspect, BA from the portion of the plurality of stations associated with the first AP are transmitted simultaneously with BA from the portion of the plurality of stations associated with the second AP.

In other embodiments, BA from the portion of the plurality of stations associated with the first AP are transmitted sequentially with BA from the portion of the plurality of stations associated with the second AP.

In some of the sequential BA embodiments, a MultiUser Block Acknowledgement Request (MU-BAR) is transmitted before receiving the BA.

In some embodiments of either broad aspect, the Co-BF/Co-SR Scheduling Information comprises a one-bit indication whether the first AP is transmitting a greater number of spatial streams than the second AP.

In a third broad aspect of the present disclosure, the first portion of the DL Co-BF/Co-SR PPDU comprises a header with a UHR-SIG field, the UHR-SIG field comprising a list of user records in an order wherein a number of spatial streams indicated in the first user record is greater than or equal to the number of spatial streams indicated in any other user record, all records of users associated with the same AP are listed consecutively, and if a first AP is transmitting a number of spatial streams greater than a number of users associated with a second AP, the user records associated with the first AP are listed first.

According to a fourth broad aspect of the present disclosure, a method of communicating using MAPC may comprise, at a first AP, transmitting, to a second AP, a trigger frame containing Co-BF/Co-SR scheduling information including: address information referring to the second AP; a set of bits indicating a number of a plurality of wireless stations scheduled by the first AP and the second AP for synchronized transmission of a Co-BF/Co-SR DL PPDU; an indication of a first number of spatial streams for the first AP to transmit the Co-BF/Co-SR DL PPDU; and an indication of a second number of spatial streams for the second AP to transmit the Co-BF/Co-SR DL PPDU. The method may further comprise transmitting, to the plurality of wireless stations by a first set of spatial streams equal in number to the first number of spatial streams, a first portion of the Co-BF/Co-SR DL PPDU in synchronization with transmission of a second portion of the Co-BF/Co-SR DL PPDU from the second AP to the plurality of wireless stations by a second set of spatial streams equal in number to the second number of spatial streams. The method may still further comprise receiving one or more BA frames transmitted from the plurality of wireless stations.

In some embodiments of the fourth broad aspect, the Co-BF/Co-SR scheduling information further includes a two-bit indication of a cumulative total number of LTFs transmitted by the first and second APs in the Co-BF/Co-SR DL PPDU.

In some embodiments of the fourth broad aspect, the trigger frame may include a user info field including a first user info subfield, and the address information referring to the second AP is stored as an AID12 in a first 12 bits of the first user info subfield. In some embodiments, the trigger frame may further include a common info field defining a trigger type set to exclude trigger-dependent user info from the user info field. In some embodiments, the user info field may be eighty bits long, the AID12 of the second AP may be repeated at a forty first bit to a fifty second bit of the user info field, and the Co-BF/Co-SR scheduling information may be stored in at least a subset of bits including a thirteenth bit to a fortieth bit and a fifty third bit to an eightieth bit of the user info field. In some embodiments, the user info field may be 120 bits long, the AID12 of the second AP may be repeated at a forty first bit to a fifty second bit of the user info field and at an eighty first bit to a ninety second bit of the user info field, and the Co-BF/Co-SR scheduling information may be stored in at least a subset of bits including a fifty third bit to an eightieth bit and a ninety third bit to a hundred and twentieth bit of the user info field. In some embodiments, the trigger frame may comprise a common info field with a trigger type set to allow trigger-dependent user info in the user info field. In some embodiments, the first user info field may further include: the AID12 of the second AP; a set of 28 bits after the AID12 of the second AP; and a set of trigger-dependent user info bits beyond the set of 28 bits. The Co-BF/Co-SR scheduling information may be stored in at least a subset of bits among the set of 28 bits and the set of trigger-dependent user info bits. In some embodiments, the trigger type of the common info field may be set to a value greater than eight.

In some embodiments of the fourth broad aspect, the trigger frame may include a common info field containing: a trigger-dependent user info subfield, a trigger type subfield set to a value greater than eight, and a bit indicating an absence of a special user info field. The Co-BF/Co-SR scheduling information may be stored in at least a subset of bits of the common info field including: a fifth bit to a fifty fifth bit of the common info field, a fifty seventh bit to a sixty fourth bit of the common info field, and the trigger-dependent user info subfield.

In some embodiments of the fourth broad aspect, the Co-BF/Co-SR scheduling information may further include RU/SS allocations for use in block acknowledgement by a first portion of the plurality of wireless stations having an association with the first AP. In some embodiments, the Co-BF/Co-SR scheduling information may further include further RU/SS allocations for use in block acknowledgment by a second portion of the plurality of wireless stations having an association with the second AP.

In some embodiments of the fourth broad aspect, each BA frame from the first portion of the plurality of wireless stations may be received simultaneously with each BA frame received from the second portion of the plurality of wireless stations. In some embodiments, the method of claim 13 each BA frame from the first portion of the plurality of wireless stations is received using a respective RU in a lower half of a bandwidth previously used for transmitting the Co-BF/Co-SR DL PPDU. Each BA frame from the second portion of the plurality of wireless stations is received using a respective RU in an upper half of the bandwidth previously used for transmitting the Co-BF/CO-SR DL PPDU. In some embodiments, for each BA frame from the first portion of the plurality of wireless stations, a respective bandwidth for the respective RU may be equal to the lower half of the bandwidth previously used for transmitting the Co-BF/Co-SR DL PPDU divided by a first number of wireless stations equal in number to the first portion of the plurality of wireless stations, and for each BA frame from the second portion of the plurality of wireless stations, a respective bandwidth for the respective RU may be equal to the upper half of the bandwidth previously used for transmitting the Co-BF/Co-SR DL PPDU divided by a second number of wireless stations equal in number to the second portion of the plurality of wireless stations. In some embodiments, each BA frame may have associated thereto: a number of spatial streams set to one, a respective number of LTFs set to a fixed value of 1 or 2, a guard interval set to a fixed value of 1.6 μs, a respective modulation and coding scheme set to a fixed value of MCS0 or MCS1, a LTF length of 2×-LTF, and a forward error correction coding being block convolution coding. In some embodiments, the Co-BF/Co-SR DL PPDU may include, for each of the first AP and the second AP, indications of a respective AP transmission power, a respective length of a trigger-based acknowledgement, and a respective uplink target receive power for each scheduled wireless station.

In some embodiments of the fourth broad aspect, each BA frame from the first portion of the plurality of wireless stations is received sequentially with respect to each BA frame received from the second portion of the plurality of wireless stations. In some embodiments, the method may further comprise transmitting a MU-BAR before receiving each of the one or more BA frames.

In some embodiments of the fourth broad aspect, the Co-BF/Co-SR scheduling information may further include a one-bit indication to indicate whether the first AP is to transmit the first portion of the Co-BF/Co-SR DL PPDU using a greater number of spatial streams than the second AP is to use to transmit the second portion of the Co-BF/Co-SR DL PPDU.

In some embodiments of the fourth broad aspect, the Co-BF/Co-SR DL PPDU includes a header having an UHR-SIG field, the UHR-SIG field including an ordered list of wireless stations ordering the plurality of wireless stations in accordance with an allocation of a respective number of spatial streams to each wireless station. In some embodiments, a first portion of the plurality of wireless stations may be associated with the first AP, and a second portion of the plurality of wireless stations may be associated with the second AP. The first portion of the plurality of wireless stations and the second portion of the plurality of wireless stations may be grouped consecutively in the ordered list of wireless stations. Each of the first portion of the plurality of wireless stations and the second portion of the plurality of wireless stations may be ordered in the ordered list of wireless stations to descend according to the respective number of spatial streams allocated to each wireless station. The respective number of spatial streams allocated to a leading wireless station in the ordered list of wireless stations may be greater than or equal to the respective number of spatial streams allocated for each other wireless station in the ordered list of wireless stations, with the leading wireless station belonging to either the first portion of the plurality of wireless stations or the second portion of the plurality of wireless stations. In some embodiments, the trigger frame may include information on each station of the plurality of stations ordered to correspond with ordered list of wireless stations.

According to a fifth broad aspect of the present disclosure, a method of communicating using MAPC may comprise, at a first AP, transmitting, to a second AP, a trigger frame containing Co-BF scheduling information for synchronized transmission of a Co-BF DL PPDU to a plurality of wireless stations. The method may further comprise transmitting, to the plurality of wireless stations by a first set of spatial streams, a first portion of the Co-BF DL PPDU in synchronization with transmission of a second portion of the Co-BF DL PPDU from the second AP to the plurality of wireless stations by a second set of spatial streams, the Co-BF DL PPDU having a header including: an indication of a count of the plurality of wireless stations, and a spatial configuration code indicating, in combination with the count of the plurality of wireless stations, a respective number of spatial streams allocated, from among the first set of spatial streams and the second set of spatial streams, to each wireless station of the plurality of wireless stations. The method may still further comprise receiving one or more BA frames transmitted from the plurality of wireless stations.

In some embodiments of the fifth broad aspect, the header may include an ordered list of wireless stations ordering the plurality of wireless stations in accordance with the respective number of spatial streams allocated to each wireless station. In some embodiments, a first portion of the plurality of wireless stations may be associated with the first AP, and a second portion of the plurality of wireless stations may be associated with the second AP. The first portion of the plurality of wireless stations and the second portion of the plurality of wireless stations may be grouped consecutively in the ordered list of wireless stations. Each of the first portion of the plurality of wireless stations and the second portion of the plurality of wireless stations may be ordered in the ordered list of wireless stations to descend according to the respective number of spatial streams allocated to each wireless station. The respective number of spatial streams allocated to a leading wireless station in the ordered list of wireless stations is greater than or equal to the respective number of spatial streams allocated for each other wireless station in the ordered list of wireless stations, the leading wireless station belonging to either the first portion of the plurality of wireless stations or the second portion of the plurality of wireless stations. In some embodiments, the trigger frame may include information on each station of the plurality of stations ordered to correspond with ordered list of wireless stations. In some embodiments, the respective number of spatial streams allocated to the leading wireless station in the ordered list of wireless stations may be equal to the respective number of spatial streams allocated to one or more wireless stations in the ordered list of wireless stations. The leading wireless station may belong to the first portion of the plurality of wireless stations. At least one of the one or more wireless stations belongs to the second portion of the plurality of wireless stations. In some embodiments, the header may include an UHR-SIG field, and the ordered list of wireless stations is included in the UHR-SIG field. In some embodiments, each wireless station of the plurality of wireless stations may have associated thereto a respective station identifier, and the Co-BF scheduling information indicates the respective station identifier for each wireless station of the plurality of wireless stations in an order of station identifiers corresponding to the ordered list of wireless stations.

In some embodiments of the sixth broad aspect, the Co-BF scheduling information may include: address information referring to the second AP; an indication of a first number of spatial streams for the first AP to transmit the Co-BF DL PPDU; and an indication of a second number of spatial streams for the second AP to transmit the Co-BF DL PPDU.

In some embodiments of the sixth broad aspect, the header may include an UHR-SIG field, and the indication of the count of the plurality of wireless stations and the spatial configuration code may be included in the UHR-SIG field. In some embodiments, the UHR-SIG field may include a number of on-orthogonal frequency division multiple access (non-OFDMA) users subfield, and the indication of the count of the plurality of wireless stations may be included in the number of non-OFDMA users subfield.

In some embodiments of the sixth broad aspect, the spatial configuration code may consist of a set of four bits.

According to a seventh broad aspect of the present disclosure, a method of communicating using MAPC may comprise, at a first AP, receiving a trigger frame transmitted from a second AP, the trigger frame containing Co-BF/Co-SR scheduling information including: address information referring to the first AP; a set of bits indicating a number of a plurality of wireless stations scheduled by the first AP and the second AP for synchronized transmission of a Co-BF/Co-SR DL PPDU; an indication of a first number of spatial streams for the first AP to transmit the Co-BF/Co-SR DL PPDU; and an indication of a second number of spatial streams for the second AP to transmit the Co-BF/Co-SR DL PPDU. The method may further comprise transmitting, to the plurality of wireless stations by a first set of spatial streams equal in number to the first number of spatial streams, a first portion of the Co-BF/Co-SR DL PPDU in synchronization with transmission of a second portion of the Co-BF/Co-SR DL PPDU from the second AP to the plurality of wireless stations by a second set of spatial streams equal in number to the second number of spatial streams. The method may still further comprise receiving one or more BA frames transmitted from the plurality of wireless stations.

According to an eight broad aspect of the present disclosure, a method of communicating using MAPC may comprise, at a first AP, receiving, at the first AP, a trigger frame transmitted from a second AP, the trigger frame containing Co-BF scheduling information for synchronized transmission of a Co-BF DL PPDU to a plurality of wireless stations. The method may further comprise transmitting, from the first AP to the plurality of wireless stations by a first set of spatial streams, a first portion of the Co-BF DL PPDU in synchronization with transmission of a second portion of the Co-BF DL PPDU from the second AP to the plurality of wireless stations by a second set of spatial streams, the Co-BF DL PPDU having a header including: an indication of a count of the plurality of wireless stations, and a spatial configuration code indicating, in combination with the count of the plurality of wireless stations, a respective number of spatial streams allocated, from among the first set of spatial streams and the second set of spatial streams, to each wireless station of the plurality of wireless stations. The method may still further comprise receiving one or more BA frames transmitted from the plurality of wireless stations.

According to a ninth broad aspect of the present disclosure, a method of communicating using MAPC may comprise, at a first AP, transmitting, to a second AP, a trigger frame containing Co-BF scheduling information for synchronized transmission of a Co-BF DL PPDU to a plurality of wireless stations, a first portion of the plurality of wireless stations being associated with the first AP and a second portion of the plurality of wireless stations being associated with the second AP. The method may further comprise transmitting, to the plurality of wireless stations by a first set of spatial streams, a first portion of the Co-BF DL PPDU in synchronization with transmission of a second portion of the Co-BF DL PPDU from the second AP to the plurality of wireless stations by a second set of spatial streams, the Co-BF DL PPDU having a header including: an ordered list of wireless stations ordering the plurality of wireless stations. The first portion of the plurality of wireless stations and the second portion of the plurality of wireless stations may be grouped consecutively in the ordered list of wireless stations. Each of the first portion of the plurality of wireless stations and the second portion of the plurality of wireless stations may be ordered in the ordered list of wireless stations to descend according to the respective number of spatial streams allocated to each wireless station. The respective number of spatial streams allocated to a leading wireless station in the ordered list of wireless stations may be greater than or equal to the respective number of spatial streams allocated for each other wireless station in the ordered list of wireless stations. The leading wireless station may belong to either the first portion of the plurality of wireless stations or the second portion of the plurality of wireless stations. The method may still further comprise receiving one or more BA frames transmitted from the plurality of wireless stations.

In some embodiments of the ninth broad aspect, the trigger frame may include information on each station of the plurality of stations ordered to correspond with ordered list of wireless stations.

In some embodiments of the ninth broad aspect, each wireless station of the plurality of wireless stations may have associated thereto a respective station identifier, and the Co-BF scheduling information may indicate the respective station identifier for each wireless station of the plurality of wireless stations in an order of station identifiers corresponding to the ordered list of wireless stations.

Embodiments include an electronic apparatus comprising one or more memories and processors configured with instructions executable to perform any of the aforementioned methods.

Embodiments include a non-transient computer-readable memory storing instructions that when executed by one or more processors, cause an electronic apparatus to perform any of the aforementioned methods.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 schematically shows a BSS-based multi-AP environment.

FIG. 2 shows a call diagram for MAPC as it has been proposed in IEEE 802.11bn.

FIG. 3 shows a schematic for a trigger frame format as disclosed at FIG. 9-64a of IEEE 802.11ax.

FIG. 4A shows a schematic for an enhanced high-throughput (EHT) variant for a common info field, as disclosed at FIG. 9-90b of IEEE 802.11be.

FIG. 4B shows a schematic for a EHT variant of a user info field, as disclosed at FIG. 9-90i of IEEE 802.11be.

FIG. 5A shows a schematic for an ultra-high-reliability (UHR) variant Co-BF/Co-SR extended repurposed user info field without trigger-dependent user info, according to an embodiment of the disclosure.

FIG. 5B shows a schematic for a UHR variant Co-BF/Co-SR extended non-repurposed user info field without trigger-dependent user info according to an embodiment of the disclosure.

FIG. 5C shows a schematic for a UHR variant Co-BF/Co-SR non-extended user info field with trigger-dependent user info, according to an embodiment of the disclosure.

FIG. 5D shows a schematic for a UHR variant Co-BF/Co-SR non-extended user info field with a newly allocated trigger type and trigger-dependent user info, according to an embodiment of the disclosure.

FIG. 6A shows a call diagram for MAPC onwards from transmission of a trigger frame, utilizing serial multi-user block acknowledgement requests (MU-BARs) from both of two coordinating APs, according to an embodiment of the disclosure.

FIG. 6B shows a call diagram for MAPC onwards from transmission of a trigger frame utilizing one MU-BAR from a Shared AP and BA scheduling for STAs of a Sharing AP via the trigger frame, according to an embodiment of the disclosure.

FIG. 6C shows a call diagram for MAPC onwards from transmission of a trigger frame without any MU-BAR from either of two coordinating APs and with non-fixed BA scheduling info embedded in a PPDU, according to an embodiment of the disclosure.

FIG. 7 shows a schematic for a UHR variant of a common info field for a trigger frame type with sufficient trigger-dependent common information for Co-BF/Co-SR related signaling, according to an embodiment of the disclosure.

FIG. 8A shows a schematic for a common info field in accordance with an embodiment of the present disclosure.

FIG. 8B shows a schematic for a special user info field in accordance with an embodiment of the present disclosure.

FIG. 8C shows a schematic for a user info field in accordance with an embodiment of the present disclosure.

FIG. 9 shows a schematic diagram of a device that may perform any or all operations of the above methods and features explicitly or implicitly described herein, according to different embodiments of the present disclosure.

It will be noted that throughout the appended drawings, like features are identified by like reference numerals.

### DETAILED DESCRIPTION

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof.

A wireless communication system to which embodiments of the present disclosure are applicable may be a wireless local area network (wireless local area network, WLAN) device, referred to as a wireless station, or more briefly, as a station (STA). Such a STA may be a mobile STA, but that is not a requirement. For example, as will be apparent, embodiments of the disclosure may be applicable for fixed STAs or APs. The communications device may be a wireless communications device that supports other wireless protocols.

Multi-AP collaboration schemes have been discussed as main candidate features for adoption in WLAN 802.11 standards. Enabling some degree of coordination among neighboring APs can permit more efficient utilization of limited wireless resources, such as time, frequency, power, and spatial resources. Additionally, enabling information sharing among coordinated APs (i.e., user scheduling and channel quality information) can ameliorate co-channel interference, which can become unmanageable in increasingly densified wireless networks. Therefore, embodiments may enable multi-AP coordination that can turn the interfering APs into collaborative sounding and beamforming participants for STAs located at overlapping basic service sets (BSSs).

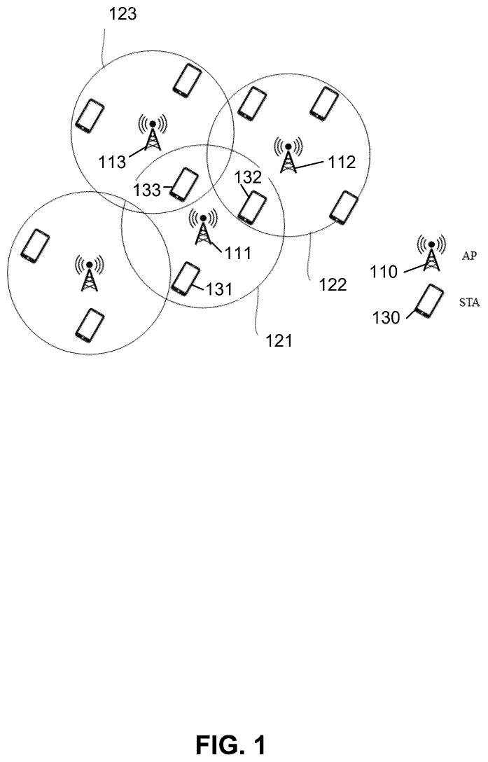

FIG. 1 schematically shows a BSS-based environment towards which embodiments of the present disclosure may be implemented. Each BSS is served by an AP 110. Accordingly, a first BSS 121 is served by a first AP 111, a second BSS 122 is served by a second AP 112, and a third BSS 123 is served by a third AP 113. Each BSS includes one or more STAs 130. A first STA 131 is within the first BSS 121, a second STA 132 is within both the first BSS 121 and the second BSS 122, and a third STA 113 is within both the third BSS 123 and the first BSS 121. The first STA 131, being within the first BSS 121, would be served by (or associated with) the first AP 111. The second STA 132, being within both the first BSS 121 and the second BSS 122, could be served by the first AP 111 or the second AP 112. However, if the second STA 133 is served by the first AP 111, it may receive co-channel interference from the second AP 112. Coordinated spatial reuse, sounding, and beamforming may resolve such co-channel interference.

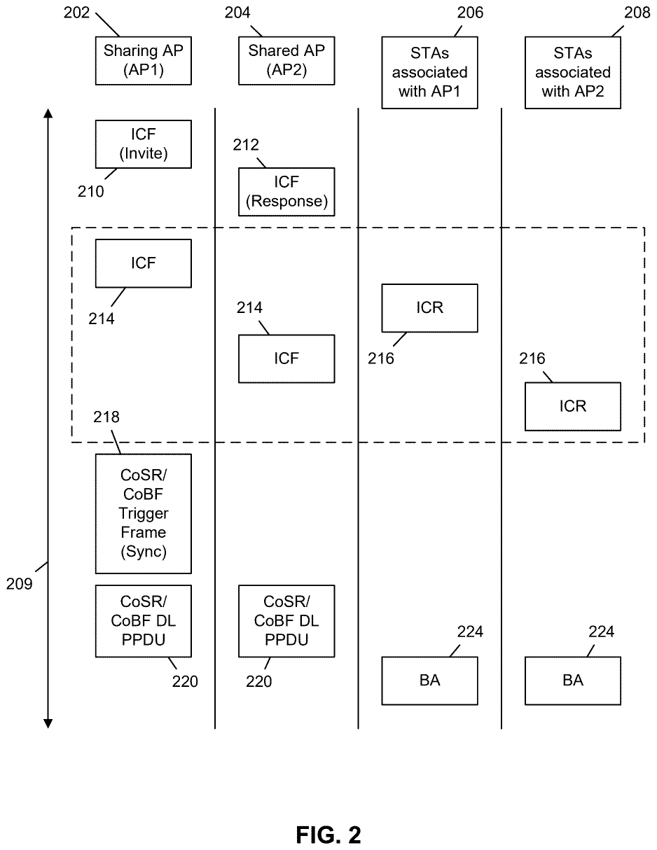

FIG. 2 shows a Sharing AP 202 (AP1) performing an ICF/ICR invitation and response sequence with a Shared AP 204 (AP2), AP1's associated STAs 206, and AP2's associated STAs 208, in accordance with an example of a currently available multi-AP coordination sequence performed for a transmission opportunity 209. During this sequence, AP1 202 sends an ICF invitation 210 to AP2 204, which responds to AP1 202 with an ICR response 212 to confirm parameters set up during MAPC agreement. AP1 202 and AP2 204 then poll their respective STAs with ICFs 214 and receive ICRs 116 in response. Each of AP1 202 and AP2 204 schedule certain associated STAs that will participate in receiving, in the case of Co-BF, a Co-BF DL PPDU.

After the ICF/ICR sequence is complete, the Sharing AP 202 sends a Co-SR/Co-BF trigger frame 218, sometimes referred to as a Sync frame, targeted to the Shared AP 204 in most scenarios. The ostensible purpose of the Co-SR/Co-BF trigger frame 218 is to solicit a Co-SR/Co-BF DL PPDU transmission 220 from the Shared AP 204 in synchronization with a Co-SR/Co-BF DL PPDU transmission 220 from the Sharing AP 202. In other words, the Co-SR/Co-BF trigger frame 218 may coordinate the transmission of a first portion of the Co-SR/Co-BF DL PPDU 220 from the Sharing AP 202 in synchronization with a transmission of a second portion of the Co-SR/Co-BF DL PDDU 220 from the Shared AP 204. The person skilled in the art will appreciate that the STAs scheduled by both AP1 and AP2 may need to acknowledge receipt of the PPDU 220 via transmission of a block acknowledgement frame 224, BlockAck, or simply BA.

However, in order to perform simultaneous BA 224, all the STAs may need to be scheduled for BA 224, namely that they may need to be informed beforehand which resource units or spatial streams (RU/SS) each one will utilize in the BA 224. In the absence of any MU-BAR trigger frame sent following the Co-BF/Co-SR DL PPDU 220 transmission, an advantageous time available for each of the Sharing AP 202 and the Shared AP 204 to provide this BA resource information to the respective scheduled STAs may be during the Co-BF/Co-SR trigger frame 218 transmission itself, which may need to be targeted at, in addition to the Shared AP 204, the scheduled STAs of one or more of the Sharing AP 202 and the Shared AP 204. As the Co-BF/Co-SR trigger frame 218 is sent from the Sharing AP 202, the Sharing AP 202 may require knowledge of the Shared AP's 204 scheduled STAs. Therefore, in order to provide RU/SS information for the scheduled STAs of the Shared AP 204 to perform simultaneous BA, the Sharing AP 202 may require knowledge of the scheduled STAs of the Shared AP 204, and in doing so may need to also receive the ICR 216 that the scheduled STAs of the Shared AP 204 send to the Shared AP 204, or acquire by other means this knowledge of the STAs scheduled for the Shared AP 204. The Sharing AP 202 may also need to utilize a Co-BF/Co-SR trigger frame format with an appropriate amount of bit space and a format that enables provision of Co-BF/Co-SR scheduling information and allocation of RU/SS to specific STAs both inside and outside the Sharing AP's 204 BSS. Simultaneous BA may include simultaneous transmission of the BA frames and simultaneous or approximately simultaneous reception of the BA frames, depending on the transit times for the BA frames.

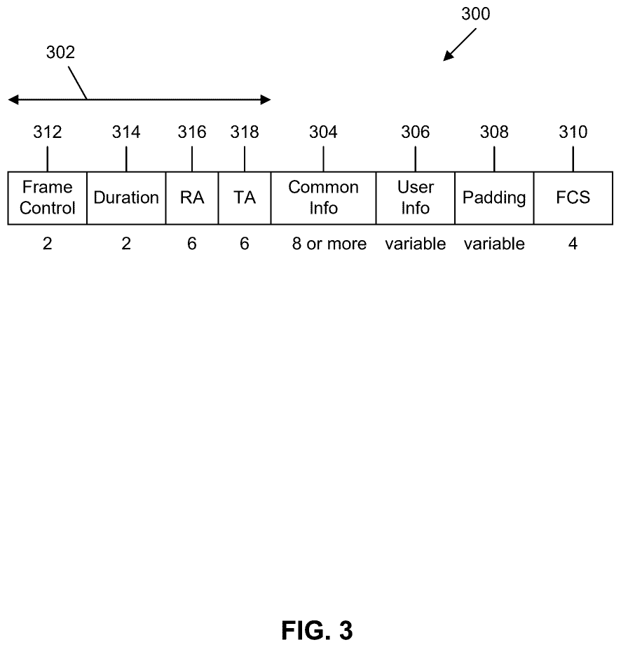

In a broad aspect of the present disclosure, a trigger frame format meeting, at least in part, the above requirements and a method of initiating Co-BF or Co-SR transmission is disclosed. The trigger frame format is based on high efficiency (HE), EHT or UHR variants of trigger frames of types not necessarily limited to BSRP, Basic, BFRP, MU-RTS, and Ranging. FIG. 3 shows an example of a format for a trigger frame 300 common to HE, EHT and UHR variants of trigger frames. The trigger frame 300 comprises a media access control (MAC) header 302, a common info field 304, a user info field 306, a field for padding 308, and a frame check sequence (FCS) field 310. The MAC header 302 further includes a frame control field 312, a duration field 314, a receiver address (RA) field 316, and a transmitter address (TA) field 318. A respective number of octets for each field is shown below the trigger frame 300 in FIG. 3.

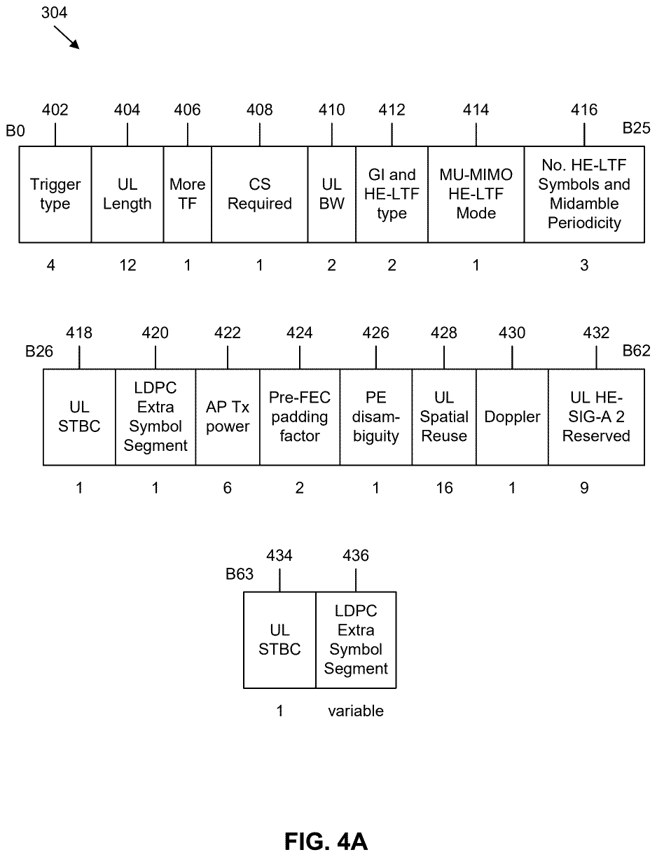

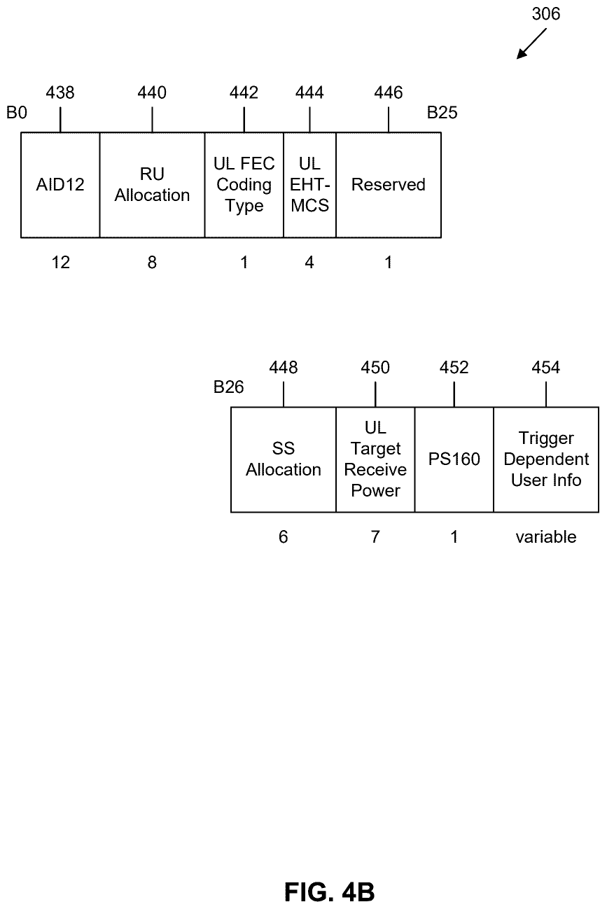

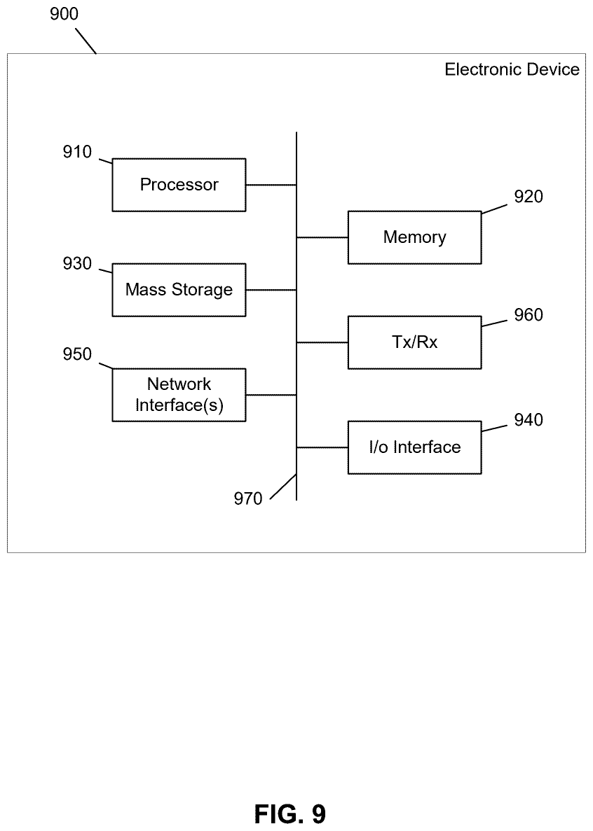

FIG. 4A shows an EHT variant of the common info field 304, formatted in accordance with FIG. 9-90b of IEEE 802.11be. The common info field 304 may comprise a subfield for a trigger type 402, which may be used to indicate trigger frame variants. The common info field 304 may further comprise subfields for indicating: uplink (UL) length 404, more TFs 406, a clear channel assessment (CS) requirement 408, UL bandwidth (BW) 410, guard interval (GI) and HE long training field (LTF) mode 412, multiple user-multiple input multiple output (MU-MIMO) HE-LTF mode 414, a number of HE-LTF symbols and midamble periodicity 416, UL space-time block coding (STBC) 418, a low-density parity-check (LDPC) extra symbol segment 420, AP Tx power 422, a pre-forward error correction (FEC) padding factor 424, packet extension (PE) disambiguity 426, UL spatial reuse 428, doppler 430, UL HE-SIG-A 2 reservation 432, UL STBC 434, and a LDPC extra symbol segment 436. A respective number of bits for each subfield is shown below the common info field 304 format in FIG. 4A and bit positions (i.e., B0, B25, etc.) are shown above. Table 1 provided below shows a list of valid values for the trigger type subfield 402 and the corresponding trigger frame variants, in accordance with FIG. 9-46b of IEEE 802.11be.

TABLE 1
Trigger frame variants by value of trigger type subfield

| Trigger Type | |
|---|---|
| Subfield Value | Trigger Frame Variant |
| 0 | Basic |
| 1 | Beamforming Report Poll (BFRP) |
| 2 | Multi-User Block Acknowledgment |
| | Request (MU-BAR) |
| 3 | Multi-User Request-to-Send (MU-RTS) |
| 4 | Buffer Status Report Poll (BSRP) |
| 5 | Group Cast (GCR) MU-BAR |
| 6 | Bandwidth Query Report Poll (BQRP) |
| 7 | Null Data Packet Feedback Report |
| | Poll (NFRP) |
| 8 | Ranging |
| 9-15 | Reserved |

FIG. 4B shows an EHT variant of the user info field 306, formatted in accordance with FIG. 9-90i of IEEE 802.11be. As shown, the information to be carried in the user info list field 306 may include subfields for: a 12-bit association identifier (AID12) 438, RU allocation 440, UL FEC coding type 442, UL EHT modulation and coding scheme (MCS) 444, reserved space 446, SS allocation 448, UL target receive power 450, primary/secondary 160 MHz (PS160) 452, and trigger-dependent user information 454. A respective number of bits for each subfield is shown below the user info field 306 format in FIG. 4B and bit positions (i.e., B0, B25, etc.) are shown above.

In embodiments of the present disclosure, the user info field 306 may include one or more user info subfields, which may provide address information referring to the Shared AP 204. The address information may, for example, be a respective AID12, which may indicate that the Co-BF/Co-SR trigger frame 218 is targeted at the Shared AP 204. Additional information that may be used by a Co-BF DL PPDU 220 (in its header, and in particular in a universal signal [U-SIG] field thereof) to aid in detection of the Co-BF DL PPDU 220 is summarized below

In embodiments of the present disclosure, two to three bits of the user info field 306 may be used to distinguish between types of MAPC trigger frames, when the ICF, Co-BF, and Co-SR trigger frame are all assigned a same format.

In embodiments for Co-BF, three bits may be used in the user info field 306 to denote a total number of scheduled STAs in Co-BF. The IEEE Ultra High Reliability task group responsible for the 802.11bn standard has limited the total number of STAs for Co-BF to four across two APs, with no more than three STAs being scheduled per AP. Thus, only six states are possible, as shown in Table 2 provided below. A three-bit index, as shown in Table 2, may be used to indicate the number of STAs per BSS in the UHR and to indicate the total number of STAs for Co-BF by simple addition.

TABLE 2
Three-bit index for indicating a
number of scheduled STAs per BSS

| | STAs AP1 | STAs AP2 |
|---|---|---|
| Index | (Sharing AP) | (Shared AP) |
| 0 | 1 | 1 |
| 1 | 1 | 2 |
| 2 | 2 | 1 |
| 3 | 2 | 2 |
| 4 | 1 | 3 |
| 5 | 3 | 1 |
| 6 | Reserved | Reserved |
| 7 | Reserved | Reserved |

Similarly, three bits may also be used to specify a number of spatial streams (N_SS) for transmission by each coordinated AP. Table 3, with a congruent arrangement to Table 2, shows values for a further three-bit index and a corresponding number of SS in each BSS.

TABLE 3
Three-bit index indicating number of spatial streams per BSS

| | Total N_SS | Total N_SS |
|---|---|---|
| Index | in Sharing AP | in Shared AP |
| 0 | 1 | 1 |
| 1 | 1 | 2 |
| 2 | 2 | 1 |
| 3 | 2 | 2 |
| 4 | 1 | 3 |
| 5 | 3 | 1 |
| 6 | Reserved | Reserved |
| 7 | Reserved | Reserved |

The two three-bit indices, provided in Tables 2 and 3, together describe a combination of the number of stations scheduled by each AP and the number of spatial streams to be transmitted by each AP. From this information, the number of spatial streams scheduled with each station may be inferred. Stated another way, six bits may be used to indicate the number of total scheduled users, number of scheduled users for each BSS, the total N_SS across two APs, and the N_SS per each user and per each BSS.

In one non-limiting example, when the index of Table 2 has a value of one and when the index of Table 3 has a value of three, AP1 may accordingly have one station with two streams scheduled, and AP2 may accordingly have two stations with two streams scheduled. AP1's only station may consequently take both streams, and AP2's two stations may consequently each take a stream. In another non-limiting example, when the index of Table 2 is two and when the index of Table 3 is five, AP1 may be assigned two stations and three streams, while AP2 may be assigned a single station with a single stream. One station at AP1 may take two streams and the other may take one stream. A convention may be used such that the first station listed in a BSS will be scheduled the greater number of streams if available. Thus, the first STA at AP1 may be given the two streams. This convention may be followed when listing STAIDs in order in a MAPC ICF/Invite frame, a MAPC Trigger/Sync frame, or in the user list of a MAPC DL PPDU ultrahigh reliability signalling (UHR-SIG) field.

In embodiments of the present disclosure, the number of LTFs (N_LTF) for a Co-BF DL PPDU 220 may be indicated by two bits. The number of LTFs in the Co-BF DL PPDU 220 may have one of two possible states, given that the N_SS_TOT would be known for the Co-BF DL PPDU 220. The number of LTFs may be either a base value or a doubled value, also referred to as “extra LTF.” The base value may be the first even number greater than or equal to the total N_SS. For three N_SS, the base value may be four. When the total N_SS is three, the doubled value may not be six, even though this is an even number. The base value may be assigned to four based on the total N_SS being three and thereafter doubled to eight.

TABLE 4
Combination of SS and LTFs for UHR coordinated beamforming

| Total N_SS | Total N_SS | Total | Minimum | N_LTF with |
|---|---|---|---|---|
| for BSS1 | for BSS2 | N_SS | N_LTF | Extra LTF |
| 1 | 1 | 2 | 2 | 4 |
| 1 | 2 | 3 | 4 | 8 |
| 1 | 3 | 4 | 4 | 8 |
| 2 | 2 | 4 | 4 | 8 |

Extra LTF may be signalled using only one bit. In addition, because the number of SS of each BSS (N_SSᵢ) can sum up to the total N_SS across the coordinated APs, the total N_SS may not be explicitly carried in a separate subfield of the Co-BF TF when each N_SSᵢ is denoted separately.

Table 4, provided above, shows a list of asymmetric states for the N_SS in one BSS and another BSS. It may be ambiguous whether the roles of the Sharing AP 202 and the Shared AP 204 roles are being played by BSS1 and BSS2, respectively, or vice versa. One bit may be used to indicate whether the TXOP holder (i.e., the Sharing AP 202) corresponds to BSS1 or BSS2 in Table 4. Alternatively, a Boolean function of whether N_SS₁ is greater than N_SS₂ may be used for this determination and one bit of overhead may be used at the cost of one comparator operation. When the number of spatial streams transmitted by each AP is equal, Table 4 may be unambiguous. When the number of spatial streams transmitted by each AP is unequal, ambiguity may be resolved by using one bit to indicate whether the TXOP winner (i.e., the Sharing AP 202) is transmitting a greater number of streams than the Shared AP 204. Whenever the number of spatial streams transmitted by each AP is equal, the aforementioned one bit may be set to a false value.

Because the total number of scheduled STAs and the N_SS of the scheduled STAs can be indicated in the Co-BF TF, the Sharing AP 202 and the Shared AP 204 may use this information to construct a U-SIG field and a UHR-SIG field for the Co-BF TF using the following rules: in a user list of the UHR-SIG of the Co-BF DL PPDU 220, the users (i.e., STAs) are to be listed in the order of from most streams allocated to least streams allocated regardless of whether each user is associated with AP1 or AP2. When the number of streams allocated to AP2 (Shared AP 204) is greater than the number of STAs scheduled by AP1 (Sharing AP 202), the STA(s) of AP2 may be listed ahead of the STA(s) of AP1. In a non-limiting example, with STA1 receiving one SS from AP1, STA2 receiving two SS from AP2, and STA3 receiving one SS from AP2, the order of appearance in a UHR-SIG user list of a Co-BF DL PPDU 220 may then be first STA2 (because it is scheduled the most streams), followed by STA3 (because it is associated with the same BSS), and lastly STA1 (because no other remaining STAs are scheduled from the other BSS). Because the user info field 306 can be exactly identified by the receiver STA according to a STAID, the order of listed users may not always have to begin with the STA(s) of AP1 (i.e., the Sharing AP 202). Hence, the list of users in the user list of a UHR-SIG of a Co-BF DL PPDU 220 may be ordered such that the user having the larger number of streams comes first, but when the number of streams are equal for the two next users, the user associated with the same AP of the previous user listed should come next. When there are only two or four scheduled users and they all receive equal streams, the user(s) scheduled by AP1 may be listed first.

In a non-limiting example, Table 5 provided below expands upon Table 4, adding possible permutations of STAs scheduled in each BSS, the resulting spatial stream allocations each STA receives, the resulting value of the one bit used to clarify whether the N_SS of BSS1 is greater than that of BSS2, and the order in which the STAs shall be listed in an ensuing UHR-SIG user list. In Table 5, STAs are numbered serially from S1 to S4, and are associated with either a first BSS (B1) or a second BSS (B2).

TABLE 5
Determination of per-station SS allocation and UHR-SIG
user list order

| | | | | N_SS | BSS1 | |
|---|---|---|---|---|---|---|
| | | | | allocated | N_SS > | Order |
| N_SS | N_SS | STAs | STAs | to each | BSS2 | listed in |
| BSS1 | BSS2 | BSS1 | BSS2 | STA | N_SS | UHR-SIG |
| 1 | 1 | 1 | 1 | 1,1 | n | B1S1 B2S2 |
| 1 | 2 | 1 | 1 | 1,2 | n | B2S2 B1S1 |
| 1 | 2 | 1 | 2 | 1,1,1 | n | B2S2 B2S3 B1S1 |
| 1 | 3 | 1 | 1 | 1,3 | n | B2S2 B1S1 |
| 1 | 3 | 1 | 2 | 1,2,1 | n | B2S2 B2S3 B1S1 |
| 1 | 3 | 1 | 3 | 1,1,1,1 | n | B1S1 B1S2 B2S3 |
| | | | | | | B2S4 |
| 2 | 1 | 1 | 1 | 2,1 | y | B1S1 B2S2 |
| 2 | 1 | 2 | 1 | 1,1,1 | y | B1S1 B1S2 B2S3 |
| 2 | 2 | 1 | 1 | 2,2 | n | B1S1 B2S2 |
| 2 | 2 | 1 | 2 | 2,1,1 | n | B1S1 B2S2 B2S3 |
| 2 | 2 | 2 | 1 | 1,1,2 | n | B2S3 B1S1 B1S2 |
| 2 | 2 | 2 | 2 | 1,1,1,1 | n | B1S1 B1S2 B2S3 |
| | | | | | | B2S4 |
| 3 | 1 | 1 | 1 | 3,1 | y | B1S1 B2S2 |
| 3 | 1 | 2 | 1 | 2,1,1 | y | B1S1 B1S2 B2S3 |
| 3 | 1 | 3 | 1 | 1,1,1,1 | y | B1S1 B1S2 B2S3 |
| | | | | | | B2S4 |

A spatial configuration subfield in each user info subfield of a UHR-SIG user list may be configured similarly as in UHR downlink MU-MIMO. A corresponding encoding table may be similar to that of the IEEE 802.11ax standard released in 2021. As inferable from Table 5, all user subfields of a UHR-SIG user list belonging to one AP and the corresponding spatial streams may be contiguous, that is, the user subfields of one AP may be together followed by the user subfields of the other AP, and the same may hold for spatial streams. The total number of users scheduled across two APs can be indicated in a “Number of Non-OFDMA Users” subfield of a UHR-SIG common field.

Table 6, provided below in accordance with IEEE 802.11ax, shows spatial configurations for different numbers of users (Nᵤₛₑᵣ), which may be used to determine the SS allocation per user (users indicated by bracketed numbers), or STA. Each spatial configuration may be indicated, in combination with the number of users, by a four-bit spatial configuration code (i.e., bits B3 to B6). For example, for three users and a spatial configuration code of 0100, a first user may be allocated two SS, a second user may be allocated two SS, and a third user may be allocated one SS. The total N_SS and a number of entries (No. Ent.) is further provided. The order of users in Table 6 follows a user list in the UHR-SIG.

TABLE 6
Spatial configuration table for allocating streams in UHR-SIG

| | | N_SS | | | | | | | | Total | No. |
|---|---|---|---|---|---|---|---|---|---|---|---|
| Nᵤₛₑᵣ | B3 . . . B6 | [1] | [2] | [3] | [4] | [5] | [6] | [7] | [8] | N_SS | Ent. |
| 2 | 0000-0011 | 1-4 | 1 | | | | | | | 2-5 | 10 |
| | 0100-0110 | 2-4 | 2 | | | | | | | 4-6 | |
| | 0111-1000 | 3-4 | 3 | | | | | | | 6-7 | |
| | 1001 | 4 | 4 | | | | | | | 8 | |
| 3 | 0000-0011 | 1-4 | 1 | 1 | | | | | | 3-6 | 13 |
| | 0100-0110 | 2-4 | 2 | 1 | | | | | | 5-7 | |
| | 0111-1000 | 3-4 | 3 | 1 | | | | | | 7-8 | |
| | 1001-1011 | 2-4 | 2 | 2 | | | | | | 6-8 | |
| | 1100 | 3 | 3 | 2 | | | | | | 8 | |
| 4 | 0000-0011 | 1-4 | 1 | 1 | 1 | | | | | 4-7 | 11 |
| | 0100-0110 | 2-4 | 2 | 1 | 1 | | | | | 6-8 | |
| | 0111 | 3 | 3 | 1 | 1 | | | | | 8 | |
| | 1000-1001 | 2-3 | 2 | 2 | 1 | | | | | 7-8 | |
| | 1010 | 2 | 2 | 2 | 2 | | | | | 8 | |

It will be appreciated that N_SS per user from AP2 may be greater than N_SS per user from AP1. In embodiments, the order of STAIDs listed in the UHR-SIG user list may be listed according to: 1) STA with a single greatest number of SS comes first (i.e., is the leading STA in the list); 2) when a tie in the number of SS occurs, a STA from AP1 is listed ahead; 3) a remainder of STAs from the AP represented by 1) or 2); and 4) STAs from the other AP in order of descending number of SS. Stated another way, the user information of the BSS having the largest N_SS in one of its scheduled STAs always comes first in the UHR-SIG user list, followed by the user information of the other BSS. In other words, the user information for each BSS may be grouped consecutively with the BSS having the user with the largest number of SS coming first. The order of STA information in the Sync or Co-BF/Co-SR trigger frame 218 may match this order as well.

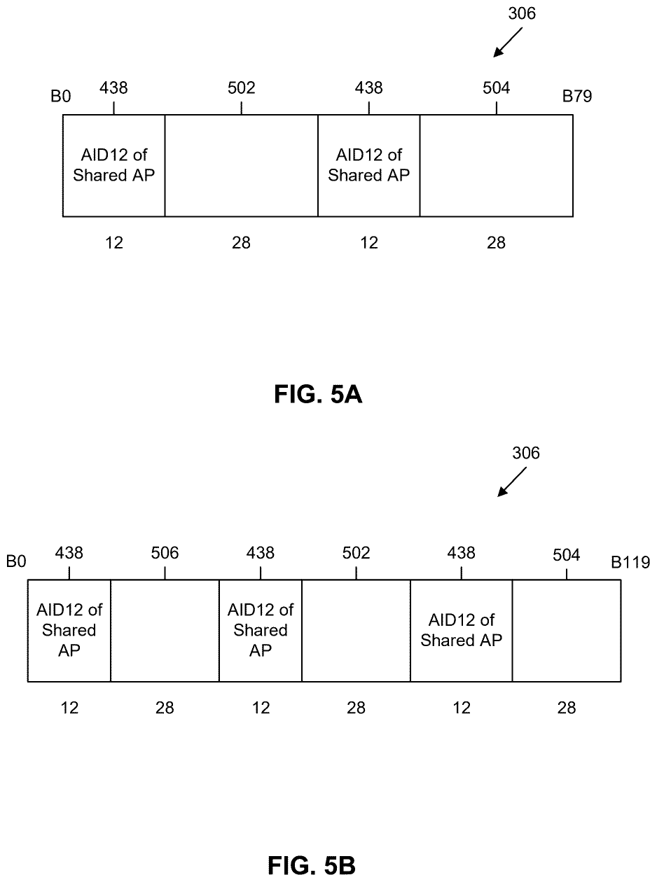

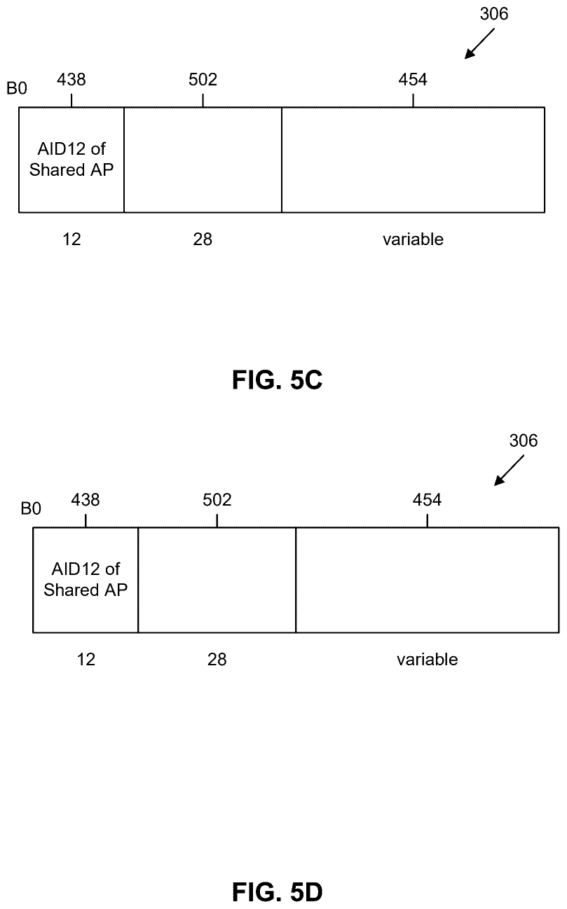

In embodiments of the present disclosure, the user info list field 306 of a Co-BF trigger frame may be arranged in a number of ways to accommodate all of the abovementioned information. Four embodiments of the present disclosure are presented in FIGS. 5A to 5D, each schematically representing the contents of the user info list field 306 of the Shared AP 204 in a Co-BF/Co-SR trigger frame 218 according to a respective embodiment. The selection of embodiment may depend on whether the repurposed trigger frame type (one of BSRP/Basic/BFRP/MU-RTS/Ranging, or another existing type, or a new type created from a reserved value of the trigger type common subfield 402) has been assigned trigger-dependent user info 454, and whether the purpose of the first 28 allocated bits of the user information after the AID12 is being preserved or repurposed (i.e., not preserved). Each segment (starting with an AID12) of the user info list field 306 presented in any one of FIGS. 5A to 5D is analogous, at least in part, to the EHT variant for the user info field 306 shown in FIG. 4B, with improvements related to the object of the present disclosure described below.

FIG. 5A shows, in accordance with an embodiment of the present disclosure, a schematic for contents of the user info field 306 wherein the chosen trigger frame type 402 does not have any trigger-dependent user info 454. Consequently, the variable length subfield at the end of the base 40 bits of one minimum unit of a user info list field 306, as shown in FIG. 4B, may not be present. The user info list field 306 of FIG. 5A comprises two user info subfields, which may each have a minimum of 40 bits, for a total of 80 bits. The AID12 subfield 438 at B0-B11 and the AID12 subfield 438 at B40-B51 may each contain the AID12 of the Shared AP 204, so that no other STA overhearing the trigger frame will find the trigger frame addressed to it. Bits B12 to B39 are repurposed from their EHT functions into entirely Co-BF/Co-SR enablement information storage 502, which may include, for example, information for generating the Co-BF/Co-SR DL PPDU 220 as discussed above. Bits B52 to B79 may also contain information 504 for generating the Co-BF/Co-SR DL PPDU 220, including RU/SS allocation information for at least the STAs scheduled by the Sharing AP. Optionally, RU/SS allocation information for the STAs scheduled by the Shared AP 204 may be included in this subfield of the user info list field 306. In FIG. 5A, the respective number of bits for each subfield is shown below the user info field 306.

FIG. 5B shows, in accordance with an embodiment of the present disclosure, a schematic for contents of the user info field 306. Similar to FIG. 5A, here, the chosen trigger frame type 402 does not have any trigger-dependent user info 454, so the variable length subfield at the end of the base 40 bits of one minimum unit of a user info list field 306 may not be present. The user info list field 306 of FIG. 5B comprises three user info subfields, which may each have a minimum of 40 bits, for a total of 120 bits. The AID12 subfield 438 at B0-B11, the AID12 subfield 438 at B40-B51, and the AID12 subfield 438 at B80-B91 each contain the AID12 of the Shared AP 204, so that no other station overhearing the trigger frame will find the trigger frame addressed to it. Bits B12 to B39 may retain their EHT functions 506, as shown in FIG. 4B, for backward compatibility with EHT. Bits B52 to B79 may contain Co-BF/Co-SR enablement information storage 502, which may include, for example, information for generating the Co-BF/Co-SR DL PPDU 220 as discussed above. Bits B92 to B119 may also contain information 504 for generating the Co-BF/Co-SR DL PPDU 220, including RU/SS allocation information for at least the STAs scheduled by the Sharing AP 202. Optionally, RU/SS allocation information for the STAs scheduled by the Shared AP 204 may be included in this subfield of the user info field list 306. In FIG. 5B, the respective number of bits for each subfield is shown below the user info field 306.

FIG. 5C shows, in accordance with an embodiment of the present disclosure, a schematic for contents of the user info field list 306. Unlike FIGS. 5A and 5B, here, the chosen existing trigger frame type 402 does have trigger-dependent user info 454, so the variable length subfield at the end of the base 40 bits of one minimum unit of a user info list field 306 minimum unit may be present. The user info list field 306 of FIG. 5C comprises one minimum unit of 40 bits plus trigger-dependent user info 454, for a total of 45 to 50 bits depending on how many bits are in trigger-dependent user info subfield 454 for the chosen trigger frame type 402. The AID12 subfield 438 at B0-B11 may contain the AID12 of the Shared AP 204, so that no other station overhearing the trigger frame will find the trigger frame addressed to it. Bits B12 to B39 may be repurposed from their EHT functions into entirely Co-BF/Co-SR enablement information storage 502, which may include, for example, information for generating the Co-BF/Co-SR DL PPDU 220 as discussed above. The trigger-dependent user info subfield 454 may also contain some information for generating the Co-BF/Co-SR DL PPDU 220, including RU/SS allocation information for at least the STAs scheduled by the Sharing AP 202. Optionally, RU/SS allocation information for the STAs scheduled by the Shared AP 204 may be included in this subfield of the user info list field 306. In FIG. 5C, the respective number of bits for each subfield is shown below the user info field 306.

FIG. 5D shows, in accordance with an embodiment of the present disclosure, a schematic for contents of the user info field 306. In the embodiment of FIG. 5D, a new Co-BF/Co-SR trigger frame type is defined by utilizing a reserved value of the trigger type subfield 402 (i.e., greater than eight) in the common info field 304. The new trigger frame type may be defined to have trigger-dependent user info 454, such that the variable length subfield at the end of the base 40 bits of one minimum unit of the user info list field 306 is present. As a newly defined field in a newly defined trigger type, a greater number of bits may be allocated than has heretofore been available in any trigger-dependent user info subfield 402. The user info list field 306 of FIG. 5D may comprises one user info field minimum unit of 40 bits plus trigger-dependent user info 454, for a total of 50 bits or more depending on the eventual requirements for the Co-BF/Co-SR trigger-dependent user info 454 for the newly dedicated trigger frame type. The AID12 subfield 438 at B0-B11 may contain the AID12 of the Shared AP 204, so that no other STA overhearing the trigger frame will find the trigger frame addressed to it. Bits B12 to B39 may be decoupled from any EHT functions because they are in a new UHT trigger frame type. These bits may be used entirely for Co-BF/Co-SR enablement information storage 502, which may include, for example, information for generating the Co-BF/Co-SR DL PPDU 220 as discussed above. The trigger-dependent user info 454 may also contain information for generating the Co-BF/Co-SR DL PPDU 220, including RU/SS allocation information for at least the STAs scheduled by the Sharing AP 202. Optionally, RU/SS allocation information for the STAs scheduled by the Shared AP 204 may be included in this subfield of the user info list field 306.

The embodiments described in relation to FIGS. 5A to 5D may facilitate flexible design of the Co-BF/Co-SR trigger frame type of user info field 306, with varying degrees of backward compatibility and overhead penalty. Each of these embodiments may be capable of supporting simultaneous BA by the scheduled stations through provision of RU/SS allocation information for BA in the Co-BF/Co-SR trigger frame 218.

Embodiments of the present disclosure may realize certain advantages by removing responsibility from the Co-BF/Co-SR trigger frame 218 for allocating BA stream/frequency resources and moving the responsibility to a separate frame, the MU-BAR trigger frame. Because the MU-BAR trigger frames may be transmitted from each AP (the Shared AP 204 and the Sharing AP 202) to their own scheduled stations, neither AP may need to become aware of the other AP's scheduling of STAs, e.g., each AP may need not overhear the ICR response frame confirming STA scheduling with the BSS overlapping its own BSS.

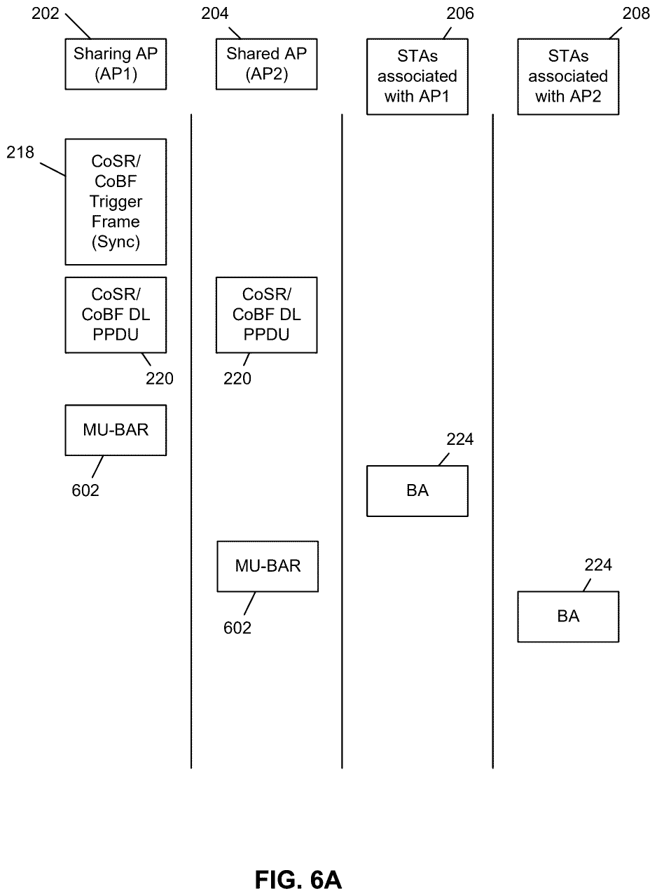

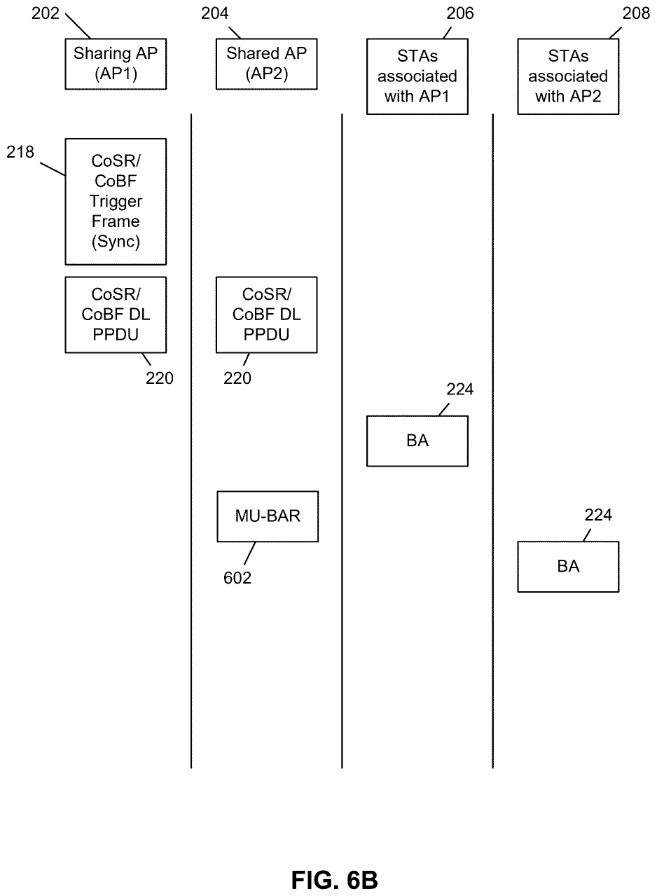

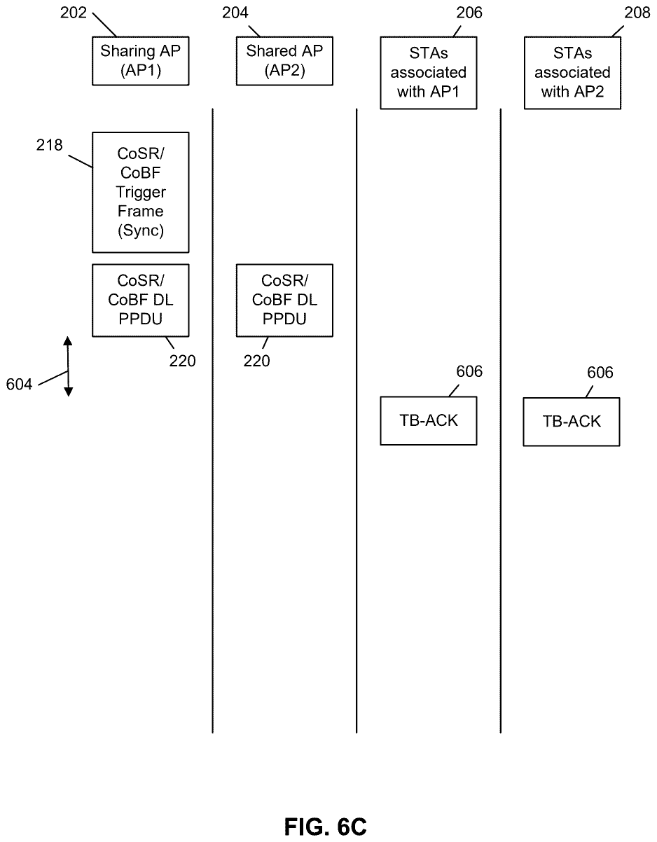

FIG. 6A shows, according to an embodiment of the present disclosure, a schematic for sequential BA 224 for each BSS, using a plurality of MU-BAR trigger frames. A first MU-BAR trigger frame 602 may be sent from the Sharing AP 202 to the STAs 206 associated with the Sharing AP 202, and a second MU-BAR trigger frame 602 may be sent from the Shared AP 204 after each STA 206 of the Sharing AP 202 responds with a respective BA 224. Each STA 208 of the Shared AP 204 may respond with a respective BA 224 after the second MU-BAR trigger frame 602 from the Shared AP 204 is sent. It will be appreciated that because the MU-BAR trigger frame is a trigger frame, each BA 224 may have a trigger-based PPDU format. The trigger-based and PPDU-based BA 224 may be scheduled in each MU-BAR trigger frame sent immediately before the BA 224.

FIG. 6B shows, according to an embodiment of the present disclosure, a schematic for sequential BA for each BSS in which the STAs 206 scheduled by the Sharing AP 202 send a BA without receiving a MU-BAR trigger frame 602. The STAs 206 scheduled by the Sharing AP 202 may receive their RU/SS allocation information in the Co-BF/Co-SR trigger frame (or Sync frame) 218 and thus may not require a MU-BAR trigger frame 602 to receive this information. In contrast, a MU-BAR trigger frame 602 may be sent by the Shared AP 204, after the STAs 206 of the Sharing AP 202 send their respective BAs 224, to schedule the BAs 224 from the STAs 208 of the Shared AP 204 that received the Co-BF/Co-SR DL PPDU 220.

Each of the embodiments described in relation to FIGS. 6A and 6B for sequential BA may relieve at least some of the burden on the Co-BF/Co-SR trigger frame 218 in providing RU/SS allocations for the BAs of scheduled STAs, and may enable streamlining of the scheduling of the resources of the Co-SR/Co-BF DL PPDU 220.

In some embodiments, the burden of scheduling resources and information for the BA may be transferred from the Co-BF/Co-SR trigger frame 218 to the Co-SR/Co-BF PPDU 220. In some embodiments, a scheme for BA, which may be referred to as concurrent BA, may use no MU-BAR trigger frames 602 to solicit an acknowledgement from STA receivers of the Co-SR/Co-BF DL PPDU 220 that are not themselves an AP. FIG. 6C shows, in accordance with these embodiments, a schematic for concurrent BA. The STAs may respond to the Co-SR/Co-BF DL PPDU 220, after a time of short interframe space (SIFS) 604, with a trigger-based acknowledgement (TB-ACK) 606.

A number of streams for each TB-ACK 606 may be fixed to one stream transmitted per acknowledging STA. A number of UHR-LTFs in each TB-ACK 606 may be standardized at a single value (either one for normal LTF or two for double LTF) but may be invariant from this value once standardized. As fixed values, these parameters may be known by the STAs and may not be required to be transmitted in the Co-BF/Co-SR DL PPDU 220.

A guard interval (GI) may be fixed to an invariant value, e.g. 1.6 μs, and a UHR-LTF length may be fixed at 2×-LTF. A FEC coding type may be constrained only to block convolution coding (BCC). These fixed parameters may also be known in advance by the STAs and therefore may not be redundantly transmitted in the Co-BF/Co-SR DL PPDU 220.

Common info to be included explicitly in a Co-BF/Co-SR DL PPDU 220 may comprise the AP TX power 422 and a length of the TB-ACK 606. The length of the TB-ACK 606 may be computed based on an invariant MCS (preferably a robust one such as MCS0 or MCS1), a number of users scheduled per BSS, and a bandwidth of the TB-ACK 606. The length of the TB-ACK 606 for a BSS with more than one STA may be longer than that needed for one STA to perform acknowledgment. The length of the TB-ACK 606 reported in the Co-BF/Co-SR DL PPDU 220 will be the longer requirement between the two APs. The STAs in the BSS with the shorter TB-ACK may add padding data to equal the longer length.

In general, the bandwidth of the TB-ACK 606 may be allocated as a portion of the bandwidth of the Co-BF/Co-SR DL PPDU 220 that the TB-ACK 606 is acknowledging. Each STA 206 of the Sharing AP 202 may use RUs in a lower half of the bandwidth for the Co-BF/Co-SR DL PPDU 220, and each STA 208 of the Shared AP 204 may use RUs in an upper half of the bandwidth for the Co-BF/Co-SR DL PPDU 220. Two STAs scheduled by one AP may each use an RU that is half the bandwidth allocated for the one AP. Three STAs scheduled by one AP may divide the half of the bandwidth allocated to the one AP by four, with each STA using an RU that is one eighth of the original bandwidth for the Co-BF/Co-SR DL PPDU 220 to send its respective acknowledgement, and with the remaining fourth (fourth eighth) being simply not scheduled. The STAs will assign themselves bandwidth (either a half or a quarter of their associated AP's allotment) in the order that corresponding STA identifiers (STAIDs) appear in an UHR-SIG field of the Co-BF/Co-SR DL PPDU 220.

User-specific info may further be indicated in the Co-BF/Co-SR DL PPDU 220 and may comprise a STAID and UL target receive power. It will be appreciated that the STAID may not necessarily be required to be explicitly listed when the order of user info listed in the UHR-SIG field aligns with the order of users allocated to RUs. The UL target receive power, however, may be different for each STA that is not an AP and that is indicated explicitly for each STA that is not an AP.

The TB-ACK 606 may have a subfield for a BSS color, and this may be set to a BSS color of the Sharing AP 202, or, the BSS color may be left at zero when BSS is not utilized.

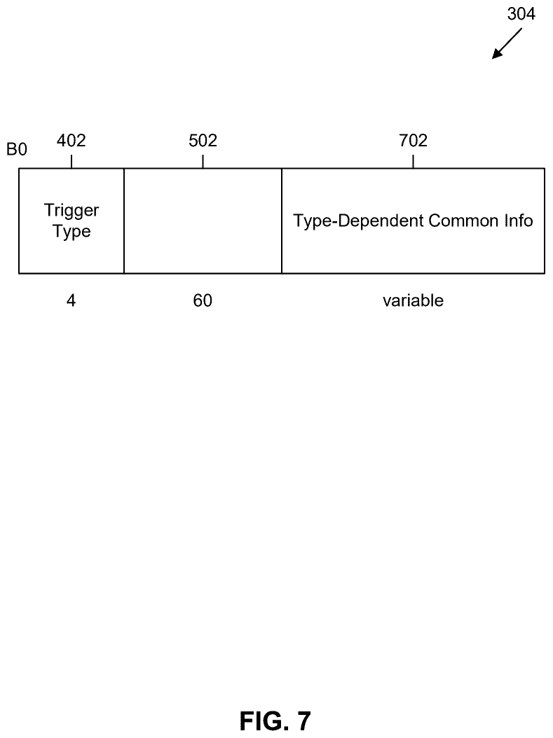

In some embodiments of the present disclosure, similar to those described in relation to FIG. 5D, a new trigger type may be defined to create a greenfield for newly allocating all the bit space within a trigger frame. The definition may include defining the common info field 304 as well as the user info field 306. FIG. 7 shows, in accordance with an embodiment of the present disclosure, a schematic for a common info field 304. The common info field 304 may include: a trigger type subfield 402; EHT or proposed UHR functionality, similar to that described in relation to FIG. 4A, at bits B4 to B63, and a type-dependent common info subfield 702 of variable length. Sufficient space may be allocated to the type-dependent common info subfield 702 for the new trigger type to fully enable Co-BF/Co-SR DL PPDU scheduling and BA scheduling, without using space in the user info list field 306 or without using a special user info field. The trigger type subfield 402, corresponding to bits B0 to B3, may be set to the value of a newly defined trigger type (i.e., by using a value previously reserved in EHT, as shown in Table 1) and bit B55 may be set to indicate an absence of a special user info field (as has been designated for bit B55 in EHT). All the other bits from B4 to B54 and B56 to B63 may be purposed for any signalling related to the Co-BF/Co-SR DL PPDU 220. The common info field 304 shown in FIG. 7 may facilitate the shortest, lowest overhead for a Co-BF/Co-SR trigger frame 218, because only a small portion of the common info field 304, and none of the user info field 306, is similar to that for EHT. In FIG. 7, the respective number of bits for each subfield is shown below the common info field 304.

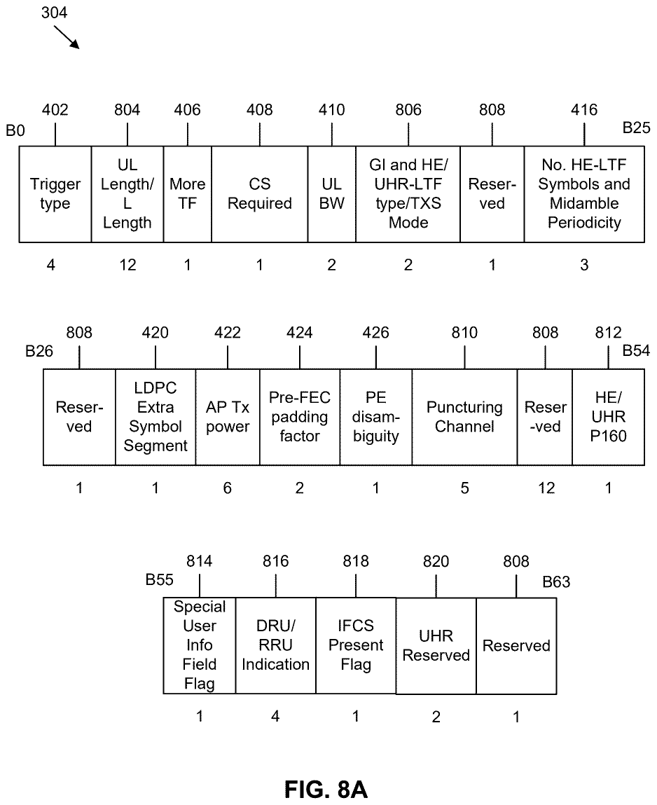

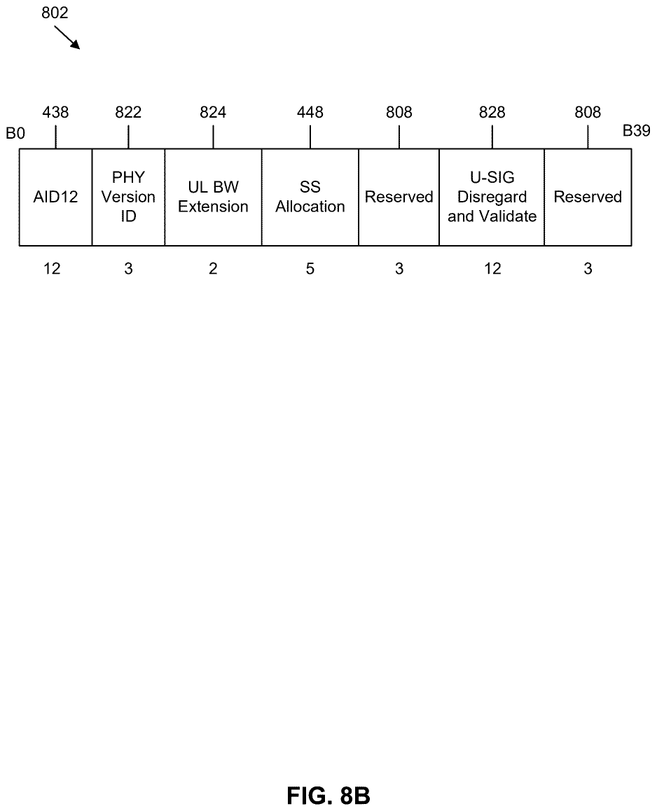

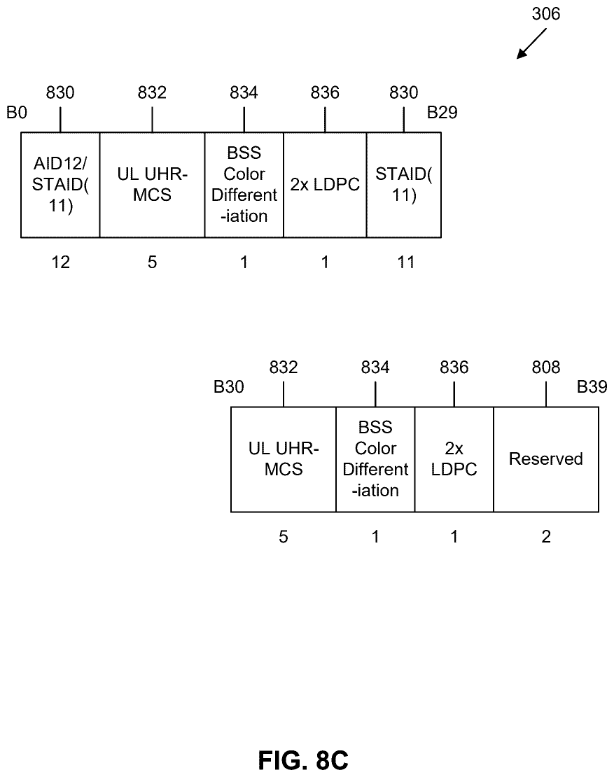

In yet further embodiments of the present disclosure, information for transmission of a Co-BF DL PPDU 220 can be carried in a Co-BF/Co-SR trigger frame 218 using a combination of a common info field 304, a special user info field 802, and a user info list field 306. FIGS. 8A, 8B, and 8C shows schema, in accordance with these embodiments, for UHR variants of the common info field 304, the special user info field 802, and the user info field 306, respectively. Information common to all the scheduled users may be carried in the common info field 304 and the special user info field 802. In addition, user-specific information such as a STAID, BSS color differentiation, UL UHR-MCS, and/or 2×LDPC may be carried in the user info field 306. As shown in FIG. 8A, the common info field 304 may include subfields for indicating: the trigger type 402, a UL length or link (L) length 804, more TF 406, UL BW 410, a GI and HE/UHR-LTF type or transmission status (TXS) mode 806, reserved space 808, a number of HE-LTF symbols and midamble periodicity 416, a LDPC extra symbol segment 420, AP Tx power 422, a pre-FEC padding factor 424, PE disambiguity 426, a puncturing channel 810, a HE/UHR 160 MHz primary channel (P160) 812, a special user info field flag 814, a distributed RU (DRU)/regular RU (RRU) indication 816, an implicit frame check sequence (IFCS) presence flag 818, and UHR reserved space 820. As shown in FIG. 8B, the special user info field 802 may include subfield for indicating: an AID12 438, a physical layer (PHY) version identifier (ID) 822, a UL BW extension 824, a SS allocation 448, reserved space 808, and U-SIG disregard and validation 828. As shown in FIG. 8C, the user info field 306 may include subfields for indicating: a AID12 or STAID 830, a UL UHR-MCS 832, BSS color differentiation 834, double-symbol low-density parity check coding (2×LDPC) 836, and reserved space 808. Each STAID 830 may be composed of 11 bits plus one dummy bit to fit the AID12 subfield 438 or may otherwise be composed of 11 bits. The user-specific information may be indicated in the user info field 306 with the corresponding STAIDs 830. The user info list field 306 shown in FIG. 8C may be considered a compressed user info field. Here, the user-specific information may be provided through 19 bits including the subfields for STAID 830 (12 bits), BSS color differentiation 834 (one bit), UL UHR-MCS 832 (five bits), and 2×LDPC 836 (one bit). The length of the user info list field 306 of any trigger frame may be 40 bits, and thus, two of the above sets of user-specific information may be compressed into each 40-bit user info field 306, with two bits remaining as reserved space 808. For example, if a total of three users are scheduled, then two sets of user-specific information may be carried in one compressed user info list field 306 and the remaining one set of user-specific information may be carried in a second compressed user info list field 306 with the remaining bits reserved as dummy padding. The inclusion of two sets of user-specific information in one compressed user info list field 306 may be enabled by moving the SS allocation subfield 448 to the common info field 304 or the special user info field 802, as shown in FIG. 8B, which may enabled by the table-based SS allocation described previously.

In some embodiments, compressing the user-specific information to 19 bits may enable the user-specific information to be included among three special user info fields 802 instead of the user info field 306. A first special user info field 802 among the three special user info fields 802 may configured similarly to that described in relation to FIG. 8B. A second special user info field 802 and a third special user info field 802 may each be configured similarly to the user info field 306 described in relation to FIG. 8C. Altogether, the three special user info fields 802 may accommodate the aggregate user information. In these embodiments, the common info field 304 may be configured as described in relation to FIG. 8A and the user info field 306, as a legacy or compressed version, may be omitted from the Co-BF/Co-SR trigger frame 218. In embodiments where the UL spatial reuse subfield 428 in the common info field 304 is repurposed and made available as reserved space 808, as shown in FIG. 8A, the user-specific information (i.e., each multiple of 19 bits) may be compressed into two special user info fields 802 while still enabling the user info list field 306 to be omitted. These embodiments may be enabled by condensing the table-based SS allocation described previously to six bits altogether, including it in the common info field 304, and removing it from the user-specific information that follows each STAID 830.

FIG. 9 is a schematic diagram of device 900 that may perform any or all of operations of the above methods and features explicitly or implicitly described herein, according to different embodiments of the present disclosure. For example, a computer equipped with network function may be configured as device 900. As may be appreciated by a person skilled in the art, the device 900 may represent one or more entities described herein, for example, an AP, a STA, or the like.

As shown, the device 900 may include a processor 910, such as a central processing unit (CPU) or specialized processors such as a graphics processing unit (GPU) or other such processor unit, memory 920, non-transitory mass storage 930, input-output interface 940, network interface 950, and a transceiver 960, all of which may be communicatively coupled via bi-directional bus 970. According to certain embodiments, any or all of the depicted elements may be utilized, or only a subset of the elements. Further, device 900 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 920 may include any type of non-transitory memory such as static random access memory (SRAM), dynamic random access memory (DRAM), synchronous DRAM (SDRAM), read-only memory (ROM), any combination of such, or the like. The mass storage element 930 may include any type of non-transitory storage device, such as a solid state drive, hard disk drive, a magnetic disk drive, an optical disk drive, USB drive, or any computer program product configured to store data and machine executable program code. According to certain embodiments, the memory 920 or mass storage 930 may have recorded thereon statements and instructions executable by the processor 910 for performing any of the aforementioned method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include number of instructions that enable a computer device to execute operations for configuring or programming a digital logic apparatus in accordance with embodiments of the present disclosure.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. A method of communicating using multi-access point (AP) coordination (MAPC) comprising, at a first AP:
transmitting, to a second AP, a trigger frame containing coordinated beamforming or coordinated spatial re-use (Co-BF/Co-SR) scheduling information including:
address information referring to the second AP;
a set of bits indicating a number of a plurality of wireless stations scheduled by the first AP and the second AP for synchronized transmission of a Co-BF/Co-SR downlink (DL) physical layer protocol data unit (PPDU);
an indication of a first number of spatial streams for the first AP to transmit the Co-BF/Co-SR DL PPDU;
and
an indication of a second number of spatial streams for the second AP to transmit the Co-BF/Co-SR DL PPDU;
and
transmitting, to the plurality of wireless stations by a first set of spatial streams equal in number to the first number of spatial streams, a first portion of the Co-BF/Co-SR DL PPDU in synchronization with transmission of a second portion of the Co-BF/Co-SR DL PPDU from the second AP to the plurality of wireless stations by a second set of spatial streams equal in number to the second number of spatial streams;
and
receiving one or more block acknowledgement (BA) frames transmitted from the plurality of wireless stations.

2. The method of claim 1 wherein the Co-BF/Co-SR scheduling information further includes a two-bit indication of a cumulative total number of long training fields (LTF) transmitted by the first and second APs in the Co-BF/Co-SR DL PPDU.

3. The method of claim 1 wherein:
the trigger frame includes a user info field including a first user info subfield,
and
the address information referring to the second AP is stored as an AID12 in a first 12 bits of the first user info subfield.

4. The method of claim 1 wherein the Co-BF/Co-SR scheduling information further includes resource unit and spatial stream (RU/SS) allocations for use in block acknowledgement by a first portion of the plurality of wireless stations having an association with the first AP.

5. The method of claim 4 wherein the Co-BF/Co-SR scheduling information further includes further RU/SS allocations for use in block acknowledgment by a second portion of the plurality of wireless stations having an association with the second AP.

6. The method of claim 5 wherein each BA frame from the first portion of the plurality of wireless stations is received simultaneously with each BA frame received from the second portion of the plurality of wireless stations.

7. The method of claim 5 wherein each BA frame from the first portion of the plurality of wireless stations is received sequentially with respect to each BA frame received from the second portion of the plurality of wireless stations.

8. The method of claim 7 further comprising transmitting a multi-user block acknowledgement request (MU-BAR) before receiving each of the one or more BA frames.

9. The method of claim 6 wherein:
each BA frame from the first portion of the plurality of wireless stations is received using a respective RU in a lower half of a bandwidth previously used for transmitting the Co-BF/Co-SR DL PPDU;
and
each BA frame from the second portion of the plurality of wireless stations is received using a respective RU in an upper half of the bandwidth previously used for transmitting the Co-BF/Co-SR DL PPDU.

10. The method of claim 9 wherein:
for each BA frame from the first portion of the plurality of wireless stations, a respective bandwidth for the respective RU is equal to the lower half of the bandwidth previously used for transmitting the Co-BF/Co-SR DL PPDU divided by a first number of wireless stations equal in number to the first portion of the plurality of wireless stations,
and
for each BA frame from the second portion of the plurality of wireless stations, a respective bandwidth for the respective RU is equal to the upper half of the bandwidth previously used for transmitting the Co-BF/Co-SR DL PPDU divided by a second number of wireless stations equal in number to the second portion of the plurality of wireless stations.

11. The method of claim 9 wherein each BA frame has associated thereto:
a number of spatial streams set to one,
a respective number of long training fields (LTFs) set to a fixed value of 1 or 2,
a guard interval set to a fixed value of 1.6 μs,
a respective modulation and coding scheme set to a fixed value of MCS0 or MCS1,
a LTF length of 2×-LTF,
and
a forward error correction coding being block convolution coding.

12. The method of claim 6 wherein the Co-BF/Co-SR DL PPDU includes, for each of the first AP and the second AP, indications of a respective AP transmission power, a respective length of a trigger-based acknowledgement, and a respective uplink target receive power for each scheduled wireless station.

13. The method of claim 1 wherein the Co-BF/Co-SR DL PPDU includes a header having an ultrahigh reliability signalling (UHR-SIG) field, the UHR-SIG field including an ordered list of wireless stations ordering the plurality of wireless stations in accordance with an allocation of a respective number of spatial streams to each wireless station.

14. The method of claim 13 wherein:
a first portion of the plurality of wireless stations is associated with the first AP;
a second portion of the plurality of wireless stations is associated with the second AP;
the first portion of the plurality of wireless stations and the second portion of the plurality of wireless stations are grouped consecutively in the ordered list of wireless stations;
each of the first portion of the plurality of wireless stations and the second portion of the plurality of wireless stations are ordered in the ordered list of wireless stations to descend according to the respective number of spatial streams allocated to each wireless station;
and
the respective number of spatial streams allocated to a leading wireless station in the ordered list of wireless stations is greater than or equal to the respective number of spatial streams allocated for each other wireless station in the ordered list of wireless stations, the leading wireless station belonging to either the first portion of the plurality of wireless stations or the second portion of the plurality of wireless stations.

15. The method of claim 14 wherein the trigger frame includes information on each station of the plurality of stations ordered to correspond with ordered list of wireless stations.

16. A method of communicating using multi-access point coordination (MAPC) comprising, at a first access point (AP):
transmitting, to a second AP, a trigger frame containing coordinated beamforming (Co-BF) scheduling information for synchronized transmission of a Co-BF downlink (DL) physical layer protocol data unit (PPDU) to a plurality of wireless stations;
transmitting, to the plurality of wireless stations by a first set of spatial streams, a first portion of the Co-BF DL PPDU in synchronization with transmission of a second portion of the Co-BF DL PPDU from the second AP to the plurality of wireless stations by a second set of spatial streams, the Co-BF DL PPDU having a header including:
an indication of a count of the plurality of wireless stations,
and
a spatial configuration code indicating, in combination with the count of the plurality of wireless stations, a respective number of spatial streams allocated, from among the first set of spatial streams and the second set of spatial streams, to each wireless station of the plurality of wireless stations;
and
receiving one or more block acknowledgement (BA) frames transmitted from the plurality of wireless stations.

17. The method of claim 16 wherein the header includes an ordered list of wireless stations ordering the plurality of wireless stations in accordance with the respective number of spatial streams allocated to each wireless station.

18. The method of claim 17 wherein:
a first portion of the plurality of wireless stations is associated with the first AP;
a second portion of the plurality of wireless stations is associated with the second AP;
the first portion of the plurality of wireless stations and the second portion of the plurality of wireless stations are grouped consecutively in the ordered list of wireless stations;
each of the first portion of the plurality of wireless stations and the second portion of the plurality of wireless stations are ordered in the ordered list of wireless stations to descend according to the respective number of spatial streams allocated to each wireless station;
and
the respective number of spatial streams allocated to a leading wireless station in the ordered list of wireless stations is greater than or equal to the respective number of spatial streams allocated for each other wireless station in the ordered list of wireless stations, the leading wireless station belonging to either the first portion of the plurality of wireless stations or the second portion of the plurality of wireless stations.

19. The method of claim 18 wherein the trigger frame includes information on each station of the plurality of stations ordered to correspond with ordered list of wireless stations.

20. The method of claim 18 wherein:
the respective number of spatial streams allocated to the leading wireless station in the ordered list of wireless stations is equal to the respective number of spatial streams allocated to one or more wireless stations in the ordered list of wireless stations;
the leading wireless station belongs to the first portion of the plurality of wireless stations;
and
at least one of the one or more wireless stations belongs to the second portion of the plurality of wireless stations.

21. The method of claim 17 wherein the header includes an ultrahigh reliability signalling (UHR-SIG) field, and the ordered list of wireless stations is included in the UHR-SIG field.

22. The method of claim 17 wherein:
each wireless station of the plurality of wireless stations has associated thereto a respective station identifier;
and
the Co-BF scheduling information indicates the respective station identifier for each wireless station of the plurality of wireless stations in an order of station identifiers corresponding to the ordered list of wireless stations.

23. The method of claim 16 wherein the header includes an ultrahigh reliability signalling (UHR-SIG) field, and the indication of the count of the plurality of wireless stations and the spatial configuration code are included in the UHR-SIG field.

24. The method of claim 23 wherein the UHR-SIG field includes a number of non-orthogonal frequency division multiple access (non-OFDMA) users subfield, and the indication of the count of the plurality of wireless stations is included in the number of non-OFDMA users subfield.

25. The method of claim 16 wherein the spatial configuration code consists of a set of four bits.

26. A method of communicating using multi-access point coordination (MAPC) comprising, at a first access point (AP):
transmitting, to a second AP, a trigger frame containing coordinated beamforming (Co-BF) scheduling information for synchronized transmission of a Co-BF downlink (DL) physical layer protocol data unit (PPDU) to a plurality of wireless stations, a first portion of the plurality of wireless stations being associated with the first AP and a second portion of the plurality of wireless stations being associated with the second AP;
transmitting, to the plurality of wireless stations by a first set of spatial streams, a first portion of the Co-BF DL PPDU in synchronization with transmission of a second portion of the Co-BF DL PPDU from the second AP to the plurality of wireless stations by a second set of spatial streams, the Co-BF DL PPDU having a header including:
an ordered list of wireless stations ordering the plurality of wireless stations, the first portion of the plurality of wireless stations and the second portion of the plurality of wireless stations being grouped consecutively in the ordered list of wireless stations, each of the first portion of the plurality of wireless stations and the second portion of the plurality of wireless stations being ordered in the ordered list of wireless stations to descend according to the respective number of spatial streams allocated to each wireless station, the respective number of spatial streams allocated to a leading wireless station in the ordered list of wireless stations being greater than or equal to the respective number of spatial streams allocated for each other wireless station in the ordered list of wireless stations, the leading wireless station belonging to either the first portion of the plurality of wireless stations or the second portion of the plurality of wireless stations;
and
receiving one or more block acknowledgement (BA) frames transmitted from the plurality of wireless stations.

27. The method of claim 26 wherein the trigger frame includes information on each station of the plurality of stations ordered to correspond with ordered list of wireless stations.

28. The method of claim 26 wherein:
each wireless station of the plurality of wireless stations has associated thereto a respective station identifier;
and
the Co-BF scheduling information indicates the respective station identifier for each wireless station of the plurality of wireless stations in an order of station identifiers corresponding to the ordered list of wireless stations.
